(19) United States
(12) Patent Application Publication
(10) Pub. No.: US 2005/0010658 A1
(43) Pub. Date: Jan. 13, 2005

(54) Method for improving the establishment of group calls between terminals, and terminal

(75) Inventor: Esa Nettamo, Oulu (FI)

Correspondence Address: Crawford Maunu PLLC, Suite 390, 1270 Northland Drive, St. Paul, MN, 55120, US

(73) Assignee: Nokia Corporation

(21) Appl. No.: 10/876,143

(22) Filed: Jun. 24, 2004

(30) Foreign Application Priority Data
Jun. 27, 2003 (FI) 20030961

(51) Int. Cl. G06F 15/173; H04M 3/00; H04M 5/00

(52) U.S. Cl. 709/223; 379/265.03

(57) ABSTRACT

A method for improving the establishment of a group call between terminals in a telecommunication system, in which at least some of the terminals maintain data in the system concerning a dynamic profile, which is available to other terminals, and which terminals maintain groups defined by the user comprising one or more terminal numbers. When a group call is being established to the terminals defined by the group provided, the profile of the terminals is checked and the group call is established based at least partly on the data provided by the profile of the terminals. In addition, a terminal in the telecommunication system is described.

### FIELD

The invention relates to establishing a group call between terminals in a telecommunication system, in which at least some of the terminals maintain data in the system on a dynamic profile that is available for the other terminals.

### BACKGROUND

The most common service offered by telecommunication systems to the users has been for some time an ordinary call from one person to another, or what is known as a point-to-point connection. Lately the operators of the telecommunication systems have offered numerous new services in addition to the conventional connections. An example of such a service is the so-called group call, in which a group of terminals may take part in the same call. Each participant in a group call may monitor the transmissions of other participants and take part in the call using their specific transmissions. The transmissions may include audio, such as a conventional call, but may also comprise other forms of data transmission, such as video.

In prior art, group call establishment the initiator of a group call selects for instance from the address book of his/her terminal the desired group, which is used for establishing the group call. The group comprises a list of telephone numbers of the participants in the group call or similar addresses. The user is able to form groups himself/herself into the address book of his/her terminal. When the group has been selected and the user has provided the terminal with a sign to initiate the call, the system attempts to establish the call between said telephone numbers. Participants may freely be added to or deleted from the list. Groups can be formed temporarily, for instance, when the user starts to establish a group call between such persons, whose data is found in the terminal of the user but who are not defined into the same group. The group is formed ad hoc when a user selects participants for a group call with his/her terminal.

An additional service that has been created recently is what is known as the use of presence information. Presence information refers to a kind of dynamic profile that the user publishes and that is available to the users that have subscribed the service. The information may comprise, for instance, data about the availability of the user and about the type of data transmission the terminal of the user supports. The data concerning all the subscribers utilizing the service is typically maintained in a server of the system, from where the user profiles that the subscribers desire can be moved into the terminal of each subscriber. Thus, the subscriber may for instance observe from the address book of the terminal the profile of the users he/she desires, which profile may comprise for instance data about whether the user concerned is available at that particular moment. From this, the subscriber may deduce whether it is worth calling the user in question at that moment.

When presence information is used for establishing a group call, the user is able to observe from the data concerning the group, which ones of the persons belonging to the group are available. In a prior art solution, the user must alter in such a case manually the participation list of the group call. Since several people may be included in the groups, the operation in question is laborious and time-consuming.

### BRIEF DESCRIPTION

It is an object of the invention to provide a method and an apparatus implementing the method so that the establishment of a group call becomes more flexible and faster. This is achieved with a method for improving the establishment of a group call between terminals in a telecommunication system, in which at least some of the terminals maintain data in the system concerning a dynamic profile, which is available to other terminals, and which terminals maintain groups defined by the user comprising one or more terminal numbers. In the method according to the invention, when a group call is being established to the terminals defined by the group provided, the profile of the terminals is checked and the group call is established based at least partly on the data provided by the profile of the terminals.

The invention also relates to a terminal in a telecommunication system, in which at least some of the terminals maintain data in the system concerning a dynamic profile, which is available to other terminals, the terminal being arranged to maintain the groups defined by the user comprising one or more terminal numbers. In the terminal according to the invention, when a group call is being established to the terminals defined by the group provided, the terminal is arranged to check the profile of the terminals and to establish a group call based at least partly on the data provided by the profile of the terminals.

The solution of the invention provides several advantages. Let us assume, for instance, that the user wishes to establish a group call between twelve participants. The presence information indicates that half of them are available. In the terminal according to the current implementation, when the group call is being established, the user has to check all the telephone numbers mentioned in the group and to make sure manually that only the participants that can be reached are included in the list for establishing the group call. The manually performed verification can be carried out for instance by removing those participants, who cannot be reached, or by selecting those participants, who can be reached. Such an operation together with a call establishment command may require, for instance, 13 key entries with current phones. In the solution according to the invention, such key entries are not required only a call establishment command is needed.

### LIST OF DRAWINGS

In the following the invention will be described in greater detail by means of the preferred embodiments with reference to the accompanying drawings, in which

FIG. 1 illustrates an example of a system, in which the embodiments can be applied,

FIG. 2 illustrates an example showing the division of a dynamic profile,

FIG. 3 illustrates an example of a group call,

FIGS. 4A to 4C illustrate examples showing methods according to some embodiments, and

FIG. 5 shows an example of a terminal.

### DESCRIPTION OF EMBODIMENTS

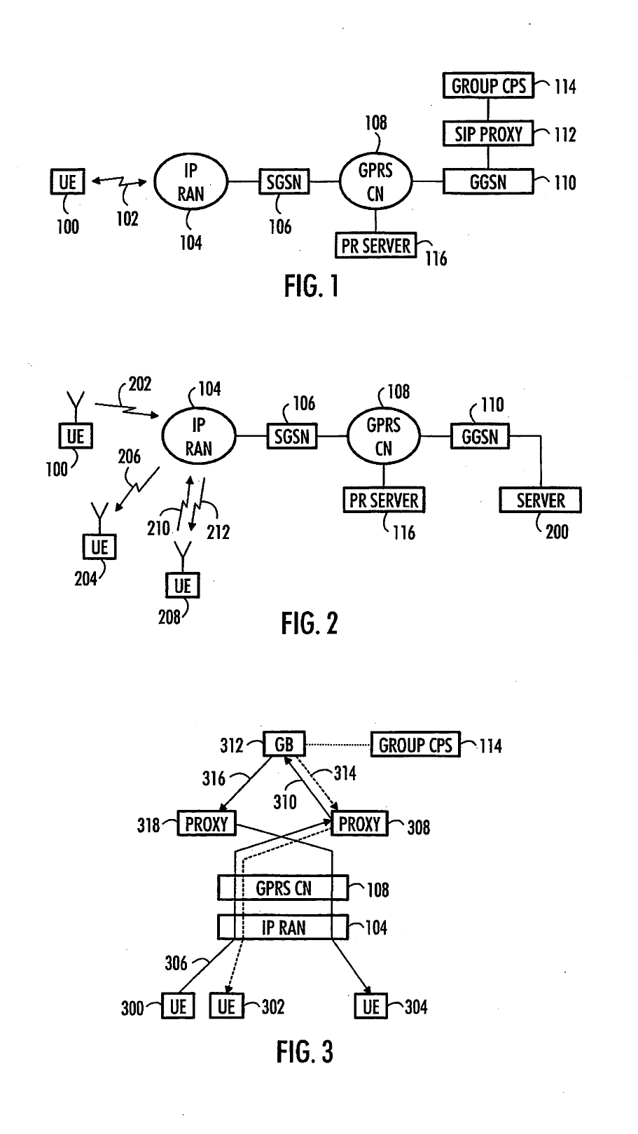

Referring to FIG. 1, let us take a closer look at an example of a telecommunication system, in which some of the embodiments of the invention can be applied. The system of FIG. 1 comprises a set of terminals 100 having a wireless connection 102 to the rest of the system through a radio access network 104 utilizing an Internet protocol. The connection between terminals is not necessarily a wireless connection, but an apparatus utilizing a wired connection can also be concerned. The radio access network is provided with a connection to a Serving GPRS Support Node, SGSN (GPRS=General Packet Radio Service) 106. The main object of the serving GPRS support node 106 is to transmit and receive packets with the user equipment 100 supporting packet-switched transmission. The serving GPRS support node 106 includes subscriber data and location information concerning the user equipment 100. The serving GPRS support node attends to the identification. From the serving GPRS support node the connection of the terminals is applied through a GPRS core network 108 to a Gateway GPRS Support Node, GGSN, 110. The gateway GPRS support node 110 routes the outgoing traffic from the core network to external networks, such as the Internet, possibly through a firewall. The network may comprise several gateway GPRS support nodes. The gateway GPRS support node 110 is provided with a connection to a proxy server 112 and to a group server 114. The system also comprises a server 116 maintaining dynamic profiles. This will be explained later on.

Through the core network, the terminals may utilize Internet-based services and connections through what is known as an Internet Protocol Multimedia Subsystem (IMS). Here, the connections between different parts are at least partly implemented based on the Internet. What is used in connection with the IMS is a Session Initiation Protocol (SIP). The SIP is defined in the IETF (Internet Engineering Task Force) standard RFC 3261. The SIP is a protocol, by which different services can be carried out. In connection with the IMS, the SIP is used for instance for establishing and managing calls. The terminal, which desires to establish either an ordinary call or a group call, sends an SIP message. When the SIP is employed, each event is composed of a request sent by a customer (SIP client). The request initiates a method or a function in the server and obtains at least one answer to the customer. For example, when a group call is desired, the terminal sends an INVOKE message to the system. The message comprises the data concerning the establishment of the group call as parameters. The SIP proxy server 112 (SIP proxy) of the system receives a message, verifies the sender, sends an acknowledgement to the sender and conveys the message to the proper receiver thereof, which in this example is the server responsible for group calls, Group CPS (Call Processing Server) 114. The Group CPS 114 is responsible for establishing the group call between the participants defined in the message.

Let us take a closer look at an example showing the division of a dynamic profile by means of FIG. 2. The system comprises a server 116 maintaining dynamic profiles. A dynamic profile, or presence information, refers to information that may comprise for instance data concerning the availability and the location of the user, and the type of data transmission supported by the user of the terminal. In addition, network elements 200 and the external applications to be driven therein may publish a profile depicting them. Let us take an example in order to illustrate such a case. The user of the terminal 100 determines the desired profile and transfers 202 the profile to the server 116 through the radio access network 104, the support node 106 and the core network 108. At the same time, the user may define to whom the information in the server is available. The user may define which parts of the profile are available to different user groups.

Some users may order the profile of said user 100 to a terminal 204 thereof, in which case always when the profile in the server is updated, the updated information is conveyed 206 to the terminal 204.

Some users may send a single inquiry 210 from the terminal 208 to the server 116 and they may be provided 212 with the current profile.

Let us take a closer look at an example showing a group call in FIG. 3. In the example shown in FIG. 3, a group call is currently taking place between three terminals 300, 302, 304. The user of the terminal 300 is speaking and the terminal 300 sends a signal 306, which is transferred through the radio access network 104 and the core network 108 to a proxy server 308 that conveys a signal 310 to a distribution server 312. The distribution server 312 distributes the signal to the other participants in the group call. The group server Group CPS 114 responsible for the group calls controls the group call. The distribution server 312 conveys a signal 314 to be forwarded to the terminal 302 to a proxy server 308 that directs the signal through the core network and the radio access network to the terminal 302. Correspondingly, the distribution server 312 conveys a signal 316 to be forwarded to the terminal 304 to a proxy server 318 that directs the signal through the core network and the radio access network to the terminal 304.

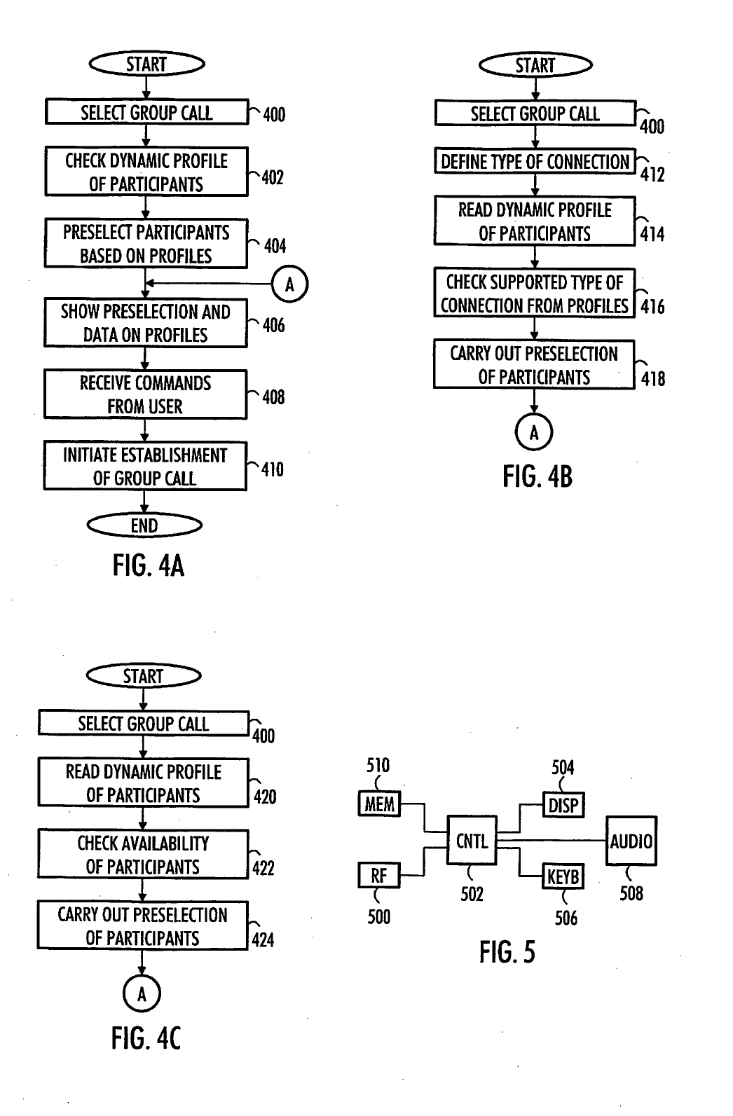

FIG. 4A illustrates an example of a method according to an embodiment. In step 400, the initiation of a group call is selected in the terminal. The group call is to be established between a particular group defined in the address book. In step 402, the dynamic profile, or presence information, of the participants belonging to the group call is checked. This information may already be stored in the terminal or said information or a part thereof can, if necessary, be loaded from the server of the system. The dynamic profile is read from those participants, from whom said profile can be obtained. In step 404, a pre-selection of participants is carried out based on the checked profiles. What pre-selection refers to in this case is that some of the participants are selected for the group between which the group call is to be established. Some of the participants mentioned in the definitions of the group call may remain unselected during this stage. In step 406, the list of participants is shown including pre-selections to the user and possibly data about the profiles. After this, the user may in step 408 manually, if desired, modify the list of the selected participants and finally provide the terminal with a call establishment command, whereby the terminal initiates in step 410 the establishment of the group call.

FIG. 4B illustrates a more detailed example of a method according to an embodiment. In step 400, the terminal is used to select the start of the group call. In step 412, the connection type of the group call is defined. This may occur automatically based on settings for instance or on the basis of a command provided by the user. Different connection types may include a connection intended for conventional speech transmission or a connection capable of transferring video or other type of data. In step 414, the dynamic profile of the participants in the group call is read. In step 416, the connection types supported by the terminals of the participants are checked. In step 418, the pre-selection of the participants is carried out based on the data obtained from the profiles. In this example, the persons belonging to the participation group in the settings of the group call whose terminal supports the selected connection type are selected to the group between which the group call is to be established. Thus, the user establishing the group call does not have to manually verify that the list concerning the establishment of the group call only includes those persons, whose terminal supports the desired connection type. After this, the process proceeds as shown in FIG. 4A, meaning that in step 406 the list of participants is shown including pre-selections to the user and possibly also the data about the profiles. The user may manually modify in step 408, if desired, the pre-selected list of participants and finally provide the terminal with the call establishment command, whereby the terminal in step 410 initiates the establishment of the group call.

FIG. 4C illustrates an example in more detail of a method according to another embodiment. In step 400, the initiation of a group call is selected in the terminal. In step 420, the dynamic profile of the participants in a group call is read. In step 422, the availability of the participants is checked from the profiles. The profile may comprise the information set by the user about whether the user is capable or willing to receive calls. In step 424, the pre-selection of participants is carried out based on the data obtained from the profiles. In this example the persons belonging to the participating group in the settings of the group call, whose profile indicates that the user is available, are selected to the group between which the group call is to be established. Thus, the user establishing the group call does not have to manually verify that the address book of the group call only includes the available participants. After this, the process proceeds as shown in FIG. 4A, i.e. in step 406 the list of participants including pre-selections is shown to the user and possibly also data about the profiles. In step 408 the user may manually, if he/she desires, modify the pre-selected list of participants and finally provide the terminal with a call establishment command, whereby the terminal initiates the establishment of the group call in step 410.

Referring to FIG. 5, let us take a closer look at an example of a terminal to which some of the embodiments of the invention can be applied. The terminal comprises radio frequency parts 500, which allows the terminal to communicate with the radio access network. The radio frequency parts can be implemented in known manners. The terminal also comprises a control unit 502 that controls the operation of the terminal. The control unit 502 can be implemented using a processor or separate logic and software. The terminal further comprises a display 504 that may be used to show information to the user and a keyboard 506, by which the user may provide the terminal with commands and audio parts 508 composed of a microphone and an earpiece. The keyboard 506 may also comprise a control stick or another user interface. The display 504 of the terminal may also be a touch screen that allows providing the apparatus with commands.

The terminal also comprises a memory 510, in which address book information has been stored that may comprise telephone numbers and groups defined by the user comprising one or more terminal numbers. The memory may also include data about the dynamic profiles of other users and the service providers in the system ordered by the user.

As the dynamic profile changes in the server of the system maintaining profiles, the system is able to send an update message to the terminal for instance using control channels. The control unit 502 of the terminal is arranged to receive the update information and to update profiles stored in the memory 510.

When the user initiates a group call, the terminal is arranged to check the profile of the terminals of the participants defined in the definition data of the group call, if such a profile is available in the memory 510. The control unit 502 detects the start of the group call from the keyboard 506 based on the commands provided. Thus, the control unit reads the necessary information from the memory. Depending on the settings of the terminal, the control unit 502 may in this context request for the missing profiles from the server maintaining profiles.

After having checked the profiles, the terminal is arranged to carry out the preselection of the participants based on the checked profiles. Here, the preselection thus refers to a situation in which some of the participants are selected to the group between which the group call is to be established. Some of the participants mentioned in the definitions of the group call can therefore remain unselected during this stage. The terminal is further arranged to show the list of participants including preselections and possibly also data about the profiles to the user on the display 504 of the terminal. The control unit 502 may show the data on the display 504 for instance graphically so that each participant defined in the settings of the group call is provided with a sign or the like, from where the user observes the preselection. After this, the user may manually, if desired, modify the list of participants using the keyboard 506 and finally provide the terminal with a call establishment command, in which case the terminal is arranged to initiate the establishment of the group call.

Even though the invention has above been explained with reference to an example according to the accompanying drawings, it is apparent that the invention is not restricted thereto but can be modified in many ways within the scope of the appended claims.

1. A method for improving the establishment of a group call between terminals in a telecommunication system, in which at least some of the terminals maintain data in the system concerning a dynamic profile, which is available to other terminals, and which terminals maintain groups defined by the user comprising one or more terminal numbers, wherein when a group call is being established to the terminals defined by the group provided, the profile of the terminals is checked and the group call is established based at least partly on the data provided by the profile of the terminals.

2. A method as claimed in claim 1, wherein the profile comprises data concerning the availability of the user of the terminal, and in that the group call is established only to the terminals defined in the group that are available.

3. A method as claimed in claim 1, wherein the profile comprises data concerning the connection types supported by the terminal, and in that the group call is established only to the terminals defined in the group that support the connection type to be used in the group call.

4. A method as claimed in claim 1, wherein data about the profiles is shown to the user of the terminal.

5. A method as claimed in claim 1, further comprising:
showing data about the profiles to the user of the terminal before establishing the group call,
receiving call establishment commands from the user,
establishing the group call based on the commands provided by the user.

6. A method as claimed in claim 1, wherein data about the profiles of the terminals is maintained in the server of the telecommunication system.

7. A method as claimed in claim 6, wherein the terminals maintain a specific copy of the profiles of the desired terminals.

8. A terminal in a telecommunication system, in which at least some of the terminals maintain data in the system concerning a dynamic profile, which is available to other terminals, the terminal being arranged to maintain the groups defined by the user comprising one or more terminal numbers, wherein when a group call is being established to the terminals defined by the group provided, the terminal is arranged to check the profile of the terminals and to establish a group call based at least partly on the data provided by the profile of the terminals.

9. A terminal as claimed in claim 8, wherein the profile comprises data concerning the availability of the user of the terminal, and in that the terminal is arranged to establish the group call only to the terminals defined in the group that are available.

10. A terminal as claimed in claim 8, wherein the profile comprises data concerning the connection types supported by the terminal, and in that the terminal is arranged to establish the group call only to the terminals defined in the group that support the connection type to be used in the group call.

11. A terminal as claimed in claim 8, wherein the terminal is arranged to
show the user of the terminal data about the profiles before establishing the group call,
receive call establishment commands from the user,
establish the group call based on the commands provided by the user.

12. A terminal as claimed in claim 8, wherein the terminal comprises a memory, in which data about the desired terminal profiles is maintained and a control unit arranged to receive and update profile data based on the update messages arriving from the system.

13. A terminal as claimed in claim 8, wherein the terminal comprises a memory, in which groups defined by the user are maintained that comprise one or more terminal numbers.

14. A terminal as claimed in claim 8, wherein the terminal comprises a control unit arranged to check the profile of the terminals, and to initiate the establishment of the group call based at least partly on the data provided by the profile of the terminals.
